(19) United States
(12) Patent Application Publication
(10) Pub. No.: US 2002/0118301 A1
(43) Pub. Date: Aug. 29, 2002

(54) Digital video effects created from spatial frequency banded frames

(76) Inventor: Michael Persiantsev, Shrewsbury, MA (US)

Correspondence Address: WILLIAM E. BOOTH, Fish & Richardson P.C., 225 Franklin Street, Boston, MA, 02110-2804, US

(21) Appl. No.: 09/794,313

(22) Filed: Feb. 27, 2001

(51) Int. Cl. H04N 9/74

(52) U.S. Cl. 348/578

(57) ABSTRACT

Method and apparatus for creating digital video effects on a frame of original image data containing pixel values. First spatial frequency banded frames are created from the frame of original image data, such that each spatial frequency banded frame contains pixels having pixel values defining an image of a different spatial frequency band of the original image data. At least some of the spatial frequency banded frames for different frames are then selectively processed to different extents. In this selective processing, the pixel values of all pixels in each spatial frequency banded frame are adjusted to the same extent. The processed spatial frequency banded frames for different spatial frequency bands are then combined to result in a processed frame having an image that is modified with respect to the original image data.

### BACKGROUND OF THE INVENTION

The invention relates to creating digital video effects on a frame of image data.

A two-dimensional image can be defined by a frame of image data including rows and columns of data defining pixels (picture elements). Each pixel can be defined by a single intensity value for black and white images, or a plurality of values for color image models (e.g., R,G,B intensities in RGB color space or Y,U,V values in Y,U,V color space). A moving image can be made up of a series of such frames of data that are used to update a display screen, e.g., 30 times a second.

It is often desirable to process pixel values for a frame or original image data for still images or a series of frames of moving video to create various video effects.

### SUMMARY OF THE INVENTION

The invention features, in general, creating digital video effects on a frame of original image data. First, spatial frequency banded frames are created from the frame of original image data such that each spatial frequency banded frame contains pixels having pixel values defining an image of a different spatial frequency band of the original image data. At least some of the spatial frequency banded frames for different frames are then selectively processed to different extents. In this selective processing, the pixel values of all pixels in each spatial frequency banded frame are adjusted to the same extent. The processed spatial frequency banded frames for different spatial frequency bands are then combined to result in a processed frame having an image that is modified with respect to the original image data.

Particular embodiments of the invention may include one or more of the following features. In preferred embodiments, the spatial frequency banded frames can be created by wavelet transformation or by Fourier transformation. More than one spatial frequency banded frame can be created for each spatial frequency band; e.g., there could be a subsampled frame, a horizontal differences frame, a vertical differences frame, and a diagonal differences frame for each spatial frequency band. The selective processing can involve multiplying all the pixel values in the same spatial frequency banded frame by the same value (e.g., a positive number or zero). The frame can have multiple channels, e.g., for different color parameters or video components or for key data describing a process to be applied to image data. When there are multiple channels of video components, separate spatial frequency banded frames are created for the components, and the frame for one component in a spatial frequency band can be processed differently than the frame for another component in the spatial frequency band.

The process and apparatus can be applied to a series of original frames defining moving video. The spatial frequency bands in sequential frames could be selectively processed the same from one original frame to the next in the series; alternatively, the selective processing of spatial frequency bands could be different for at least some different original frames in the series.

Spatial frequency banded frames can also be created from a second (different) frame of original image data; the spatial frequency banded frames can then be selectively processed to different extents and combined with the processed spatial frequency banded frames for the first original frame to create a video effect. Different effects can also be created by providing a second set of spatial frequency banded frames which are considered keys that are combined with the processed spatial frequency banded frames for the first original frame.

Embodiments of the invention may include one or more of the following advantages. Various video effects can be easily and automatically applied to image data. E.g., fine details can be emphasized or de-emphasized, and transitions between scenes in moving video can be created in a unique way.

Other advantages of the invention will be apparent from the following description of particular embodiments thereof and from the claims.

### BRIEF DESCRIPTION OF THE DRAWINGS

FIG. 1 is a diagram showing a frame of pixels representing a two-dimensional image.

FIG. 2 is a block diagram illustrating a system and process for creating digital video effects.

FIG. 3 is a diagram illustrating the creation of a series of spatial frequency banded frames of different resolutions.

FIG. 4 is a block diagram illustrating a first alternative process for creating digital video effects.

FIG. 5 is a block diagram illustrating a second alternative process for creating digital video effects.

### DETAILED DESCRIPTION OF PARTICULAR EMBODIMENTS

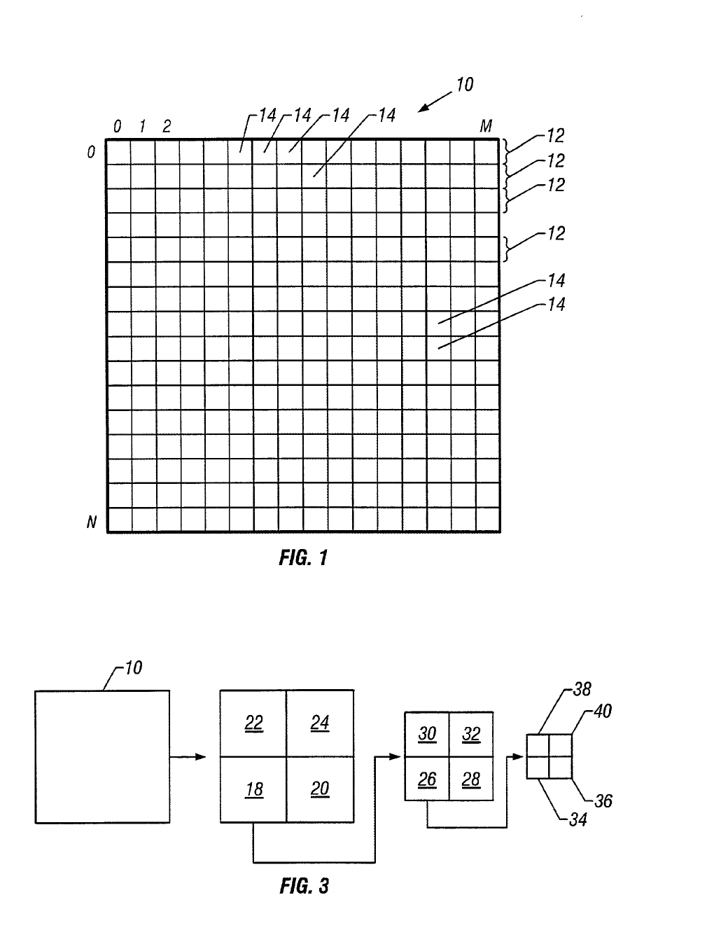

Referring to FIG. 1, it is seen that frame 10 includes n rows12 of pixels 14, and that there are m pixels in each row. As noted above, each pixel could be represented by a single value for black and white images or multiple values for color images.

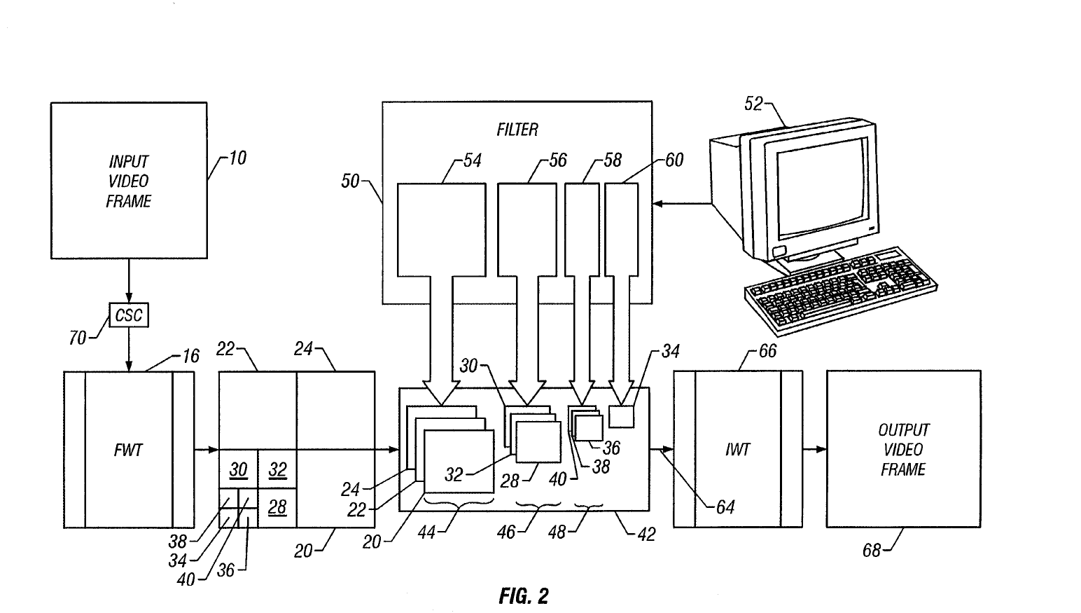

Referring to FIG. 2, input frame 10 is input to frequency transformer 16, which, in the FIG. 2 embodiment, is a wavelet analyzer. In each pass through the wavelet analyer, the frame data are reduced in half vertically and horizontally to result in four blocks 18, 20, 22, 24, as is shown in FIG. 3. Referring to FIGS. 2 and 3, block 18 includes the average values while the other three blocks include horizontal differences (block 20), vertical differences (block 22), and diagonal differences (block 24). Block 18 of average values has one half as many vertical columns and horizontal rows as the original frame (it is a subsampled frame of the original frame 10); in effect, average filter block 18 has excluded the upper spatial frequency band of video data. Original frame 10 of image data can be reconstructed from blocks 18-24 by using the average values block 18 and the differences of blocks 20, 22, 24. In a second pass through the wavelet analyzer, the average block 18 is again reduced in half to result in new average block 26 and differences blocks 28, 30, 32. The image in average block 26 has one-fourth as many vertical columns and horizontal rows as original frame 10, and has excluded the upper frequency band of the first block of average data 18. A third pass through the wavelet analyzer is also illustrated in FIG. 3, resulting in a third average block 34 and differences blocks 36, 38, 40.

Blocks 18-40 are so-called “Mallat blocks,” which are stored in buffer memory 42 (FIG. 2). A group of three related Mallat blocks, consisting of a horizontal, vertical and diagonal components, represents a “resolution.” FIG. 2 shows first, second and third resolutions 44, 46, 48. The blocks in each resolution are also considered “spatial frequency banded frames” that define an image of a spatial frequency band of the original image data in frame 10. Thus the frames in resolution 44 relate to a higher spatial frequency band than the frames in resolution 46, which relate to a lower spatial frequency band, and the frames in resolution 48 and frame 34 relate to even lower spatial frequency bands.

Digital pixel values in each resolution can be attenuated or amplified (multiplied by a factor less than one or greater than one) in filter (also referred to as an equalizer) 50, which is controlled by a user at personal computer 52. In filter 50, all pixels in each block of a resolution are multiplied by the same factor at a respective multiplier 54, 56, 58, 60, though different factors can be used in the different resolutions to achieve desired effects. The resulting filtered Mallat blocks are then fed at 64 into synthesizer 66, a wavelet synthesizer in the FIG. 2 embodiment, where a modified frame 58 is assembled and output.

By way of example, a user at pc 52 can give a higher weighting to the lower frequencies (i.e., in block 34, or resolution 48) to have an image devoid of details (e.g., a cat without its whiskers), or a user might give a higher weight to the higher frequencies (i.e., in resolution 44) to emphasize the details (e.g., a cat with intensified whiskers).

FIG. 2 illustrates an example for one component of a digital image (e.g., the luminance). In the case or multiple-component color images, e.g., YUV or RGB images, the data for each color component are operated upon in the same manner. Thus, there could be three channels, one for Y, one for U and one for V, as shown in FIG. 2, for processing in parallel. Alternatively, the data for each component could be processed sequentially, one after the other.

A user could employ a color space converter (e.g., converter 70, shown in phantom in FIG. 2) to act on the pixel values in frame 10 prior to processing in frequency transformer 16 to achieve different effects. The weighting provided by multipliers 54-60 could be the same or different for the resolutions in different channels. For example, different multiplier settings may be applied to multipliers 54-60 for luminance and chrominance components of a video frame. For example, chrominance components may be attenuated in low-frequency resolutions and left unaltered (or even amplified) in high-frequency resolutions. One could also invert a component or cross-fade chrominance components within a resolution, to bring about yet further effects.

FIG. 2 illustrates the process for a single image frame, which could be a still image or a single frame of a series of frames in moving video. In the latter case, frames in the series could be processed one after the other.

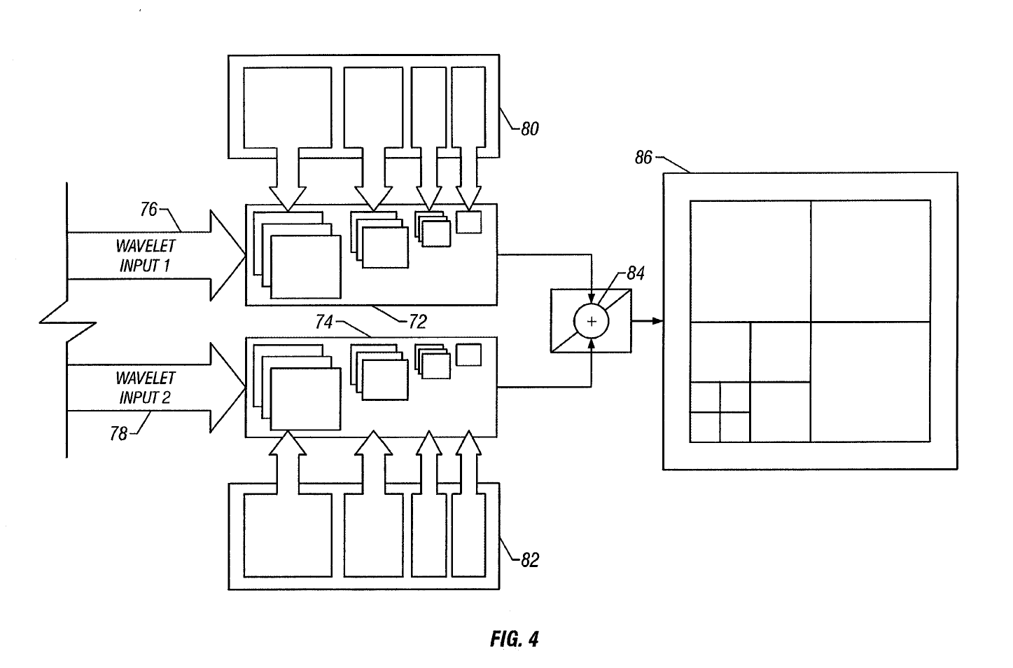

FIG. 4 shows a further embodiment in which two filter blocks are combined to form a mixing device, to mix image data from two sources, e.g., two video streams being mixed. Wavelet resolutions 72, 74 of two independent video streams 76, 78 are individually filtered by filters 80, 82 and then blended in combiner 84 prior to wavelet synthesis, while both frames are still in the wavelet domain. The output 86 represents a mix of two original frames, with independently modified spatial spectra.

The embodiment of FIG. 4 can be employed as a transition generator, where, e.g., high frequency components of one video stream could initially start to fade away and be replaced by high frequency components of another video stream, and then the process could be repeated for lower resolutions, etc., until the first video stream has been entirely replaced by the second video. In this case, the transitional video may exhibit the general appearance of a first scene, with superimposed contours from the second, which become more and more pronounced.

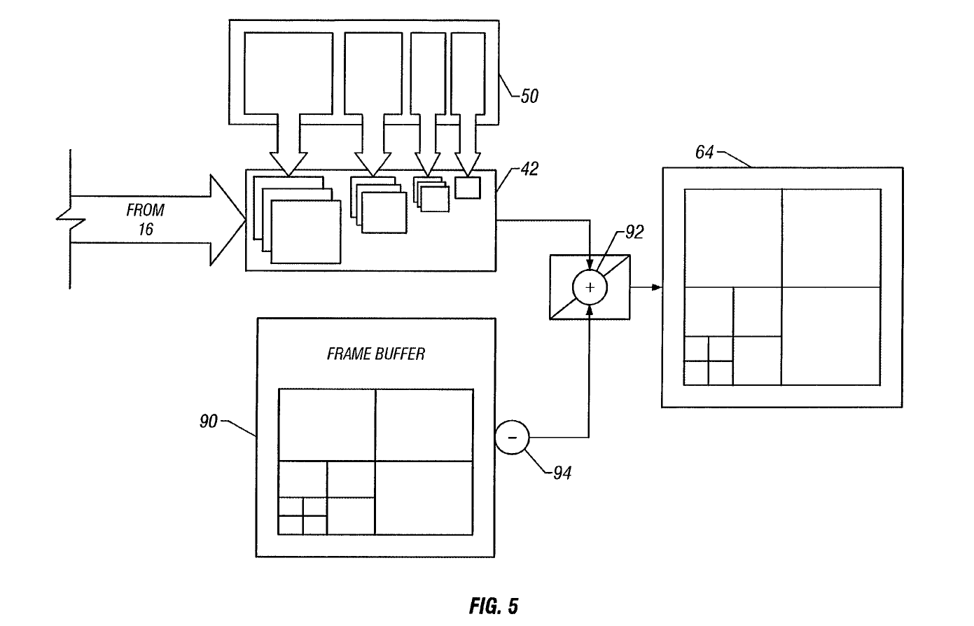

FIG. 5 shows a further embodiment in which an additional memory buffer 90 is added to the basic configuration of FIG. 2. Memory buffer 90 is used to store a selected “keyframe” which is subtracted from subsequent frames in a moving video stream at combiner 92. Inverter 94 negates the digital values of the samples representing a frame. This configuration can be used to create interesting motion effects, such as, for example, a sharp object moving against a fuzzy background.

Effects can be stored on disk or other storage media and later retrieved by saving the vector of multiplier settings that are used on an initial frame, on a final frame and on a number of in-between frames, such that the actual settings for each frame can be interpolated from these values.

The system can be implemented in software or in hardware. In the hardware implementation, frequency transformer 16 could be a wavelet analysis core, filter 50 could be an arithmetic unit with an external interface to pc 52 or another control panel, and synthesizer 66 could be a wavelet synthesis core. There also could be additional input/output devices, buffers and image processing circuits used in conjunction with the systems described in FIGS. 2, 4 and 5 for transporting and processing digital video data in order to, e.g., receive, process and output moving video in real time.

The systems could be used as stand-alone systems for post-production or real-time video equalization and mixing. The systems could also be provided as software or hardware plug-in modules for existing: (1) image processing applications such as Adobe Photoshop and After Effects; (2) professional digital video effects generators, such as those sold by Avid, Tektronix, and Media, 100; and (3) video capture boards and/or other digital video equipment, such as units available from Truevision and Matrox.

Other embodiments of the invention are within the scope of the appended claims. For example, instead of a wavelet synthesizer, other techniques and equipment can be employed to provide spatial frequency banded frames 18-34, e.g., Fourier transformation.

What is claimed is:

1. A method of creating digital video effects on a first original frame of original image data containing pixel values, said method comprising
creating first spatial frequency banded frames from said first frame of original image data, each said spatial frequency banded frame containing pixels having pixel values defining an image of a different spatial frequency band of said original image data,
selectively processing at least some of said first spatial frequency banded frames to different extents, the pixel values of all pixels in each first spatial frequency banded frame being adjusted to the same extent, said selectively processing resulting in processed first spatial frequency banded frames for different spatial frequency bands, and
combining said processed spatial frequency banded frames for different spatial frequency bands to result in a processed frame having an image that is modified with respect to said original image data.

2. The method of claim 1 wherein said selectively processing involves multiplying all said pixel values in a said spatial frequency banded frame by the same value.

3. The method of claim 2 wherein said value is a positive number or zero.

4. The method of claim 1 wherein said frame has multiple channels.

5. The method of claim 4 wherein said multiple channels are different color parameters.

6. The method of claim 4 where one said channel has image data and another channel contains key data describing a process to be applied to said image data.

7. The method of claim 1 wherein said original image data includes video components, and wherein said creating spatial frequency banded frames involves creating separate spatial frequency banded frames for said components.

8. The method of claim 7 wherein said selectively processing involves processing the frame for one component in a spatial frequency band differently than the frame for another component in said spatial frequency band.

9. A method of creating digital video effects on a series of original frames of original image data containing pixel values defining moving video, said method comprising
carrying out the following steps for each said original frame of original image data:
creating spatial frequency banded frames from each said frame of original image data, each said spatial frequency banded frame containing pixels having pixel values defining an image of a different spatial frequency band of said original image data of a respective frame of original image data,
selectively processing at least some of said spatial frequency banded frames to different extents, the pixel values of all pixels in each spatial frequency banded frame being adjusted to the same extent, said selectively processing resulting in processed spatial frequency banded frames for different spatial frequency bands, and
combining said processed spatial frequency banded frames for different spatial frequency bands to result in a processed frame having an image that is modified with respect to said original image data.

10. The method of claim 9, wherein said selectively processing said spatial frequency banded frames is the same from one original frame to the next in the series.

11. The method of claim 9, wherein said selectively processing said spatial frequency banded frames is different for at least some different original frames in the series.

12. The method of claim 1, wherein said selectively processing includes processing said spatial frequency banded frames at the same time.

13. The method of claim 1 wherein said creating spatial frequency banded frames includes wavelet transformation.

14. The method of claim 1 wherein said creating spatial frequency banded frames involves creating more than one spatial frequency banded frame for each spatial frequency band.

15. The method of claim 14 wherein there are a subsampled frame, a horizontal differences frame, a vertical difference frame, and a diagonal differences frame for each said spatial frequency band.

16. The method of claim 1 wherein said creating spatial frequency banded frames includes a Fourier transformation.

17. The method of claim 1 further comprising
creating second spatial frequency banded frames from a second frame of second original image data, each said second spatial frequency banded frame containing pixels having pixel values defining an image of a spatial frequency band of said second original image data,
selectively processing at least some of said second spatial frequency banded frames to different extents, the pixel values of all pixels in each second spatial frequency banded frame being adjusted to the same extent, said selectively processing resulting in processed second spatial frequency banded frames for different spatial frequency bands, and
combining said first and second processed spatial frequency banded frames for the same spatial frequency band together prior to said combining of processed spatial frequency banded frames for different spatial frequency bands.

18. The method of claim 1 further comprising
providing second spatial frequency banded frames for different spatial frequency bands, and
combining said first processed spatial frequency banded frames and said second spatial frequency banded frames for the same spatial frequency band together prior to said combining of processed spatial frequency banded frames for different spatial frequency bands.

19. Apparatus for creating digital video effects on a first original frame of original image data containing pixel values, said apparatus comprising
a frequency transformer that receives said first frame of said original image data and creates first spatial frequency banded frames from said first frame of original image data, each said spatial frequency banded frame containing pixels having pixel values defining an image of a spatial frequency band of said original image data,
a filter that receives said first spatial frequency banded frames and selectively processes at least some of said first spatial frequency banded frames to different extents, the pixel values of all pixels in each first spatial frequency banded frame being adjusted to the same extent, said filter outputting processed first spatial frequency banded frames for different spatial frequency bands, and
a synthesizer that combines said processed spatial frequency banded frames for different spatial frequency bands and outputs a processed frame having an image that is modified with respect to said original image data.

20. The apparatus of claim 19 wherein said frequency transformer is a wavelet analyzer.

21. The apparatus of claim 19 wherein said frequency transformer executes a Fourier transform.
